(19) United States
(12) Patent Application Publication
(10) Pub. No.: US 2005/0207347 A1
(43) Pub. Date: Sep. 22, 2005

(54) Provisioning control apparatus

(76) Inventors: Hiroshi Ishinishi, Yokohama (JP); Hiroshi Yoshitake, Yokohama (JP); Takashi Iwasaki, Yokohama (JP)

Correspondence Address: KATTEN MUCHIN ROSENMAN LLP, 575 MADISON AVENUE, NEW YORK, NY, 10022-2585, US

(21) Appl. No.: 10/895,186

(22) Filed: Jul. 20, 2004

(30) Foreign Application Priority Data
Mar. 16, 2004 (JP) 2004-074748

(51) Int. Cl. H04L 12/56

(52) U.S. Cl. 370/241

(57) ABSTRACT

In a provisioning control apparatus which performs provisioning of network devices in order to construct a predetermined network architecture on a network composed of the network devices, a command generator generates a network setup command for making the predetermined network architecture to be provided to the network devices, a network status analyzer acquires operation status information of the network devices determined based on the setup result, and analyzes a network architecture state based on operation status information. A provisioning controller determines the network setup command based on the analysis result and demands the command generator to generate the command.

### BACKGROUND OF THE INVENTION

1. Field of the Invention

The present invention relates to a provisioning control apparatus, and in particular to a provisioning control apparatus which performs provisioning of network devices in order to construct a predetermined network architecture on a network composed of the network devices.

Together with recent rapid developments of communication technology, network devices (routers, switches, etc.) composing a network have been provided with functions for supporting e.g. a VLAN network, a VPN network, an MPLS, and the like, and have become all the more complicated and advanced, thereby realizing various network services (network architectures) using the functions.

In order to realize the network services, it is required for a provisioning control apparatus (provisioning management system) to perform provisioning (setup) of network devices at a time of e.g. a new architecture/change of a network, a shutdown of a network device, a line fault occurrence, or a recovery from a line fault.

2. Description of the Related Art

“Provisioning”, which is defined as “a series of processes of assigning or setting up network resources in order to satisfy a certain demand” in “Overview and Principles of Internet TE” of RFC3272, means to perform a network setup to network devices for a certain purpose. Hereinafter, the network setup is occasionally referred to simply as provisioning.

Examples of advanced network services are an IP-VPN (Internet Protocol Virtual Private Network) service which realizes on an IP network a VPN (Virtual Private Network) service using an existing leased line network, a wide-area VLAN service developed in a wide-area VLAN which mutually connects locations in a VLAN (Virtual Local Area Network) used as an intranet per intra-enterprise location, and the like.

As the network services have been thus advanced, it is required to set up a complicated network setup command for numerous network devices dispersed in a wide area, and to perform provisioning (setup) of a predetermined network architecture corresponding to the network services over the network.

Accordingly, a demand for the provisioning control apparatus requires functions of identifying numerous network devices dispersed in a wide area per network service, and of setting up the complicated network setup command necessary for realizing the concerned service for each network device.

Namely, a system which can automatically set up the network setup command per network service desirable to be realized in all of network devices related is required. For example, the system is to enable numerous network devices existing on a network managed and operated and lines mutually connecting the network devices to be automatically set up in all of network devices related only by operating a GUI of a system architecture screen or the like.

FIG. 25 shows a prior art example of a provisioning control apparatus (provisioning management system) 100z, which is connected to network devices 200_1-200_4 (hereinafter, occasionally represented by a reference numeral 200) composing a network 300.

The provisioning management system 100z is provided with a provisioning controller 10z, a command generator 12, a command transmitter/receiver 13, a download data processor 17, and a download data backup DB 24.

In operation, the provisioning management system 100z performs provisioning of the network devices 200 for providing a network service. At that time, the provisioning management system 100z backs up provisioning data (setup data) set up in the network devices 200 to its own download data backup DB 24.

When a fault occurs in e.g. the network device 200_1, the network device 200_1 is exchanged with a normal network device 200. Then, the provisioning management system 100z sets up the network device 200 with the provisioning data backed up. Thus, a long-term abort of the network service can be avoided (see, e.g. Patent document 1).
[Patent document 1] Japanese patent application laid-open No. 11-306110 (page 3, FIG. 1)

While provisioning (network setup operation) of various network services has become easy in the prior art provisioning management system, it is still very difficult to set up all of a series of network setup commands without problems for the network devices 200 dispersed in a wide area and operated.

Although the network setup command itself to be set up has no problem at a syntax level in the prior art provisioning management system for example, the provisioning sometimes fails in the middle of the processing in the following cases: (1) access to the network device 200 is disabled due to a fault of the network device 200 itself that is a setting up object; (2) lines mutually connecting the network devices 200 are changed; (3) a physical bandwidth of a line is already exceeded upon setting up a usage bandwidth of the line.

This is because a system support in case of a network setup command failure is not sufficient in the prior art provisioning management system.

When such a failure of the provisioning process occurs, it is required for a network operator to investigate the causes of the failure, to wait for a recovery of the failed network devices and completion of lines change maintenance operation based on the investigation result, and to retry the failed provisioning, i.e. to reset the network setup command.

Furthermore, the management of the network setup command has become very complicated because of the following facts: (1) a series of network setup commands for realizing the network service are hierarchized, and hierarchies are mutually related and complicated, (2) the network service is realized by combining a plurality of service functions, (3) the service functions are mutually related.

Meanwhile, when the provisioning fails in the middle of the processing (when the processing is aborted), for example, the prior art provisioning management system can not manage a network service operatable level indicating up to which service function setup of the network services to be realized has been completed, or the like. Namely, it is very difficult to clarify an effect range for the setup failure of the network setup command, and to specify the network service operatable level upon setup failure in the management system.

In order to counter such problems, a network operator skilled in a network management operation has determined a correction range of the network setup command and the effect range of the service operation relying on his or her experience and instinct, performed an investigation or the like to the network service operatable level at the present time, and performed a correction operation of provisioning data of the network device 200 manually.

Since there is no function supporting the correction operation in the prior art provisioning management system, cooperation between the manual operation and the provisioning management system can not be performed, so that an effect of introducing the provisioning management system is halved, thereby leading to an increased operation management cost.

Also, in the case of the provisioning management system 100z shown in FIG. 25, the provisioning data (network setup command) preliminarily backed up during a normal operation are reset upon a setup failure. However, since the provisioning data backed up are all of the provisioning data including other network services set up in the network devices 200 before the provisioning process start, other unrelated network services to the provisioning failure are aborted.

Furthermore, together with advancement and variety of network services, the provisioning data set up to the network device 200 drastically increase, and a processing time proportional to a provisioning data amount is required in a resetting method of all the provisioning data. Namely, network services having nothing to do with the failure are stopped, and a stop time before the recovery is increased together with the advancement and diversification of network services.

### SUMMARY OF THE INVENTION

It is accordingly an object of the present invention to provide a provisioning control apparatus which performs provisioning of network devices in order to construct a predetermined network architecture on a network composed of the network devices, wherein highly reliable provisioning is promptly performed when a network service (network architecture) is newly set up or updated, or faults of the network devices or lines occur, and provisioning for such a provisioning failure is performed.

In order to achieve the above-mentioned object, a provisioning control apparatus, according to the present invention, performing provisioning of network devices in order to construct a predetermined network architecture on a network composed of the network devices comprises: a command generator generating a network setup command for making the predetermined network architecture, providing the network setup command to the network devices, and receiving a setup result from the network devices; a network status analyzer acquiring operation status information of the network devices determined based on the setup result and outputting an analysis result of a network architecture state based on the operation status information acquired; and a provisioning controller instructing the command generator to generate the network setup command determined based on the analysis result.

FIG. 1 shows a principle of a provisioning control apparatus 100 according to the present invention. This provisioning control apparatus 100 is provided with a command generator 12, a network status analyzer 15, and a provisioning controller 10.

Generally, a network 300 is composed of a plurality of network devices 200_1-200_4 (hereinafter, represented by a reference numeral 200), transmission lines connecting these devices, and the like.

The provisioning control apparatus 100 is connected to each of the network devices 200, and performs provisioning (setup) of each of the network devices 200 in order to construct a predetermined network architecture (e.g. network architecture for VLAN network service or the like composed according to a customer's demand) on the network 300.

Firstly, in order to perform this provisioning, the provisioning controller 10 instructs the command generator 12 to generate a network setup command 800 in order to construct a predetermined network.

The command generator 12 generates the instructed network setup command 800, provides the network setup command 800 to a predetermined network device 200, and receives its setup result 801 from each network device 200.

The network status analyzer 15 acquires operation status information (network information) 802 of each network device 200 determined based on the setup result 801 through e.g. an SNMP (not shown), and analyzes a network architecture state based on the operation status information 802 to output an analysis result 803.

The provisioning controller 10, based on the analysis result 803, determines a subsequent network setup command, and instructs the command generator 12 to generate the command.

Thus, it becomes possible to promptly perform provisioning with a higher reliability than the prior art provisioning only based on the command setup result 801, when a network architecture (network service) is newly set up or updated, or faults of the network devices or lines occur.

Also, in the present invention according to the above-mentioned present invention, the provisioning controller may develop an effect into subsequent provisioning based on the analysis result, and may determine a network setup command subsequently generated based on a result of the effect development.

Namely, when having failed in e.g. provisioning process, the provisioning controller develops an effect into the subsequent provisioning based on the analysis result. When a fault has occurred in the network device for example, the provisioning controller analyzes whether or not the fault has an effect on switchover process and subsequent provisioning process since access to the object network device 200 itself can not be performed, and determines the network setup command subsequently generated.

Thus, it becomes possible to perform provisioning which avoids an effect caused by e.g. a failure factor of the previous provisioning process.

It is to be noted that this effect development may be performed at a service function level in case where the network architecture described later is composed of a plurality of service functions, or it may be performed at a command level or a command group level.

Also, in the present invention according to the above-mentioned present invention, the predetermined network architecture may be realized by a plurality of provisionings, a provisioning status level may be associated with each provisioning, the provisioning controller may update the provisioning status level based on the setup result, and the network status analyzer may determine the operation status information to be acquired based on a provisioning status level at which provisioning has failed.

Namely, the network architecture is realized with a plurality of provisionings. A method of dividing the provisionings is not prescribed here. A provisioning status level is associated with each provisioning.

The provisioning controller updates the provisioning status level based on the setup result of each provisioning, and the network status analyzer determines the operation status information to be acquired based on a provisioning status level at which provisioning has failed.

Thus, the provisioning is managed by the provisioning status level, thereby enabling the provisioning for such a provisioning failure to be performed.

Also, in the present invention according to the above-mentioned present invention, the provisioning status level may be associated with a plurality of service functions composing the predetermined network architecture, a network setup command group for realizing each service function, or a network setup command.

Namely, the provisioning status level may be associated with a plurality of service functions composing a predetermined network architecture to be determined, and may be associated with a command group or each command for realizing each service function.

FIG. 2 shows an example in which the provisioning status level is associated with the service function.

FIG. 2 shows a service function example (1) composing a predetermined network architecture (network service). The network architecture is composed of a VLAN function, an ESRP function, and an EoMPLS function. The provisioning status level is set up to each function.

It is to be noted that a plurality of same service functions, e.g. the VLAN functions exist in the network architecture in some cases, where the service functions are not associated with the provisioning status levels in a one-to-one relationship.

The provisioning controller updates the present provisioning status, i.e. the provisioning status level of the service function during present provisioning, based on the setup result.

The network status analyzer determines the operation status information to be acquired based on the service function received as the setup result, at which provisioning has failed and the provisioning status level.

As mentioned above, the network status analyzer analyzes the acquired operation status information. The provisioning controller determines the network setup command determined based on the analysis result, and instructs the command generator to generate the network setup command.

Thus, when the predetermined network architecture is not normally established, it becomes possible to establish e.g. a second best network architecture based on the analysis result, i.e. setup result of the command and the operation status information.

Thus, it becomes possible to perform flexible and accurate provisioning process accommodating to a failure factor.

Also, in the present invention according to the above-mentioned present invention, based on the analysis result at a time when a failure of provisioning is found, the provisioning controller may switch back the provisioning.

Namely, the provisioning controller switches back e.g. the failed provisioning based on the analysis result.

Thus, even when the provisioning has failed due to e.g. a fault in a part of network and the service function corresponding to the provisioning can not be normally established, it becomes possible to exert no effect on other service functions by switching back the provisioning concerned.

Also, in the present invention according to the above-mentioned present invention, the provisioning controller may determine whether or not provisioning of a subsequent service function is performed based on the analysis result of failed provisioning.

Namely, when the provisioning has failed due to a fault in a part of the network and the service function corresponding to the provisioning can not be normally established, the provisioning controller 10 does not perform the provisioning of this service function if the fault exerts an effect on the subsequent service functions as an example.

Thus, it becomes possible to execute the provisioning in consideration of an effect development of the previous provisioning result and to eliminate unnecessary provisioning.

Also, the present invention according to the above-mentioned present invention may further comprise a database in which operation status information of network devices to be acquired per each provisioning is preliminarily set up, and the network status analyzer may determine operation status information to be acquired based on the setup result and the database.

In a database of the service function example (1) shown in FIG. 2, the operation status information (network device operation status check item in FIG. 2) to be acquired, e.g. information as to whether or not a network device fault check or a line fault check is performed is set up with respect to the VLAN function, the ESRP function, and the EoMPLS function corresponding to the provisioning. The network status analyzer determines the operation status information to be acquired based on the setup result and the database.

Thus, it becomes possible for the network status analyzer to easily determine the operation status information to be acquired.

Also, the present invention according to the above-mentioned present invention may further comprise a requisite/option management database indicating whether or not the provisioning is requisite, and the provisioning controller may abort predetermined network architecture processing when it is determined that requisite provisioning has not been performed based on the analysis result.

FIG. 3 shows a service function example (2) composing the network architecture. The network architecture of this example (2) is composed of the VLAN function, the ESRP function, and the EoMPLS function corresponding to the provisioning, similar to the service function example (1) shown in FIG. 2.

Furthermore, “requisite” is set up in the VLAN function, and “option” is set up in the ESRP function and the EoMPLS function.

When determining that the provisioning of a requisite service function has failed, the provisioning controller 10 aborts predetermined network architecture processing based on the analysis result.

On the other hand, when the provisioning of an optional service function has failed for example, the provisioning controller 10 continues provisioning process for rendering another function.

Thus, it becomes possible to abort network architecture processing which is insignificant and unnecessary so long as the provisioning of the requisite service function is not performed.

Furthermore, in the present invention according to the above-mentioned present invention, when it is determined that optional provisioning has not been set up based on the analysis result, the provisioning controller may continue provisioning of a subsequent service function.

Thus, the provisioning of a predetermined network architecture can be performed regardless of success/failure of the provisioning of the service function which is not requisite for the network architecture.

As described above, according to the provisioning control apparatus of the present invention, highly reliable provisioning can be promptly performed when a network service (network architecture) is newly set up or updated, or faults of the network devices or lines occur.

Also, only by designating requisite/option per service function for example, a system autonomously narrows down the network devices 200 related to a provisioning failure without bothering a network operator at a time of the provisioning failure, whereby the causes of the provisioning failure, and an effect range related to the provisioning subsequent to the processing failure can be determined and a correction operation such as switchback can be promptly performed.

Thus, it is eliminated to stop network services not related to the failure at the time of the provisioning failure and to prolong the time before recovery.

Also, as a result of executing the correction operation, it becomes possible to manage and present what degree of the network service enabled service function is rendered, through the provisioning status level.

Furthermore, it can contribute to man-hour reduction related to the provisioning of the network operator, so that it becomes possible to promptly realize the network service rendered by a carrier to a user.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing a principle of a provisioning control apparatus according to the present invention;

FIG. 2 is a diagram showing a service function example (1) in a provisioning control apparatus according to the present invention;

FIG. 3 is a diagram showing a service function example (2) in a provisioning control apparatus according to the present invention;

FIGS. 4A and 4B are block diagrams showing an embodiment of a provisioning control apparatus arrangement according to the present invention;

FIG. 5 is a diagram showing an example of a wide-area VLAN service definition constructed by a provisioning control apparatus according to the present invention;

FIG. 6 is a block diagram showing a network arrangement (1) in which a provisioning control apparatus according to the present invention renders a wide-area VLAN service;

FIG. 7 is a block diagram showing a network arrangement (2) in which a provisioning control apparatus according to the present invention constructs a VLAN of a wide-area VLAN service;

FIG. 8 is a block diagram showing a network arrangement (3) in which a provisioning control apparatus according to the present invention constructs an LSP and a redundancy LSP of a wide-area VLAN service;

FIG. 9 is a block diagram showing a network arrangement (4) in which a provisioning control apparatus according to the present invention constructs an EoMPLS of a wide-area VLAN service;

FIGS. 10A-10D are diagrams showing an arrangement of a database in a provisioning control apparatus according to the present invention;

FIG. 11 is a sequence diagram showing an example of a requisite/option analysis procedure in a provisioning control apparatus according to the present invention;

FIG. 12 is a sequence diagram showing an operation procedure example of network information acquisition/analysis processing in a provisioning control apparatus according to the present invention;

FIG. 13 is a sequence diagram showing an operation procedure example of provisioning status level management processing in a provisioning control apparatus according to the present invention;

FIG. 14 is a sequence diagram showing an operation procedure example of effect development processing into another provisioning in a provisioning control apparatus according to the present invention;

FIG. 15 is a sequence diagram showing an operation procedure example of switchback processing at a time of a provisioning process abort in a provisioning control apparatus according to the present invention;

FIG. 16 is a flowchart showing an operation procedure example of a provisioning controller in a provisioning control apparatus according to the present invention;

FIG. 17 is a flowchart showing an operation procedure example of a command generator in a provisioning control apparatus according to the present invention;

FIG. 18 is a flowchart showing an operation procedure example of a command transmitter/receiver in a provisioning control apparatus according to the present invention;

FIG. 19 is a flowchart showing an operation procedure example of a service setup manager in a provisioning control apparatus according to the present invention;

FIG. 20 is a flowchart showing an operation procedure example of a command abnormality analyzer in a provisioning control apparatus according to the present invention;

FIG. 21 is a flowchart showing an operation procedure example of a network status analyzer in a provisioning control apparatus according to the present invention;

FIG. 22 is a flowchart showing an operation procedure example of a network information acquiring portion in a provisioning control apparatus according to the present invention;

FIG. 23 is a diagram showing an example of a service rendering level at a time of an LSP definition failure in an operation embodiment in a provisioning control apparatus according to the present invention;

FIG. 24 is a diagram showing an example of a service rendering level at a time of an LSP redundancy definition failure in an operation embodiment in a provisioning control apparatus according to the present invention; and

FIG. 25 is a block diagram showing a prior art provisioning control apparatus.

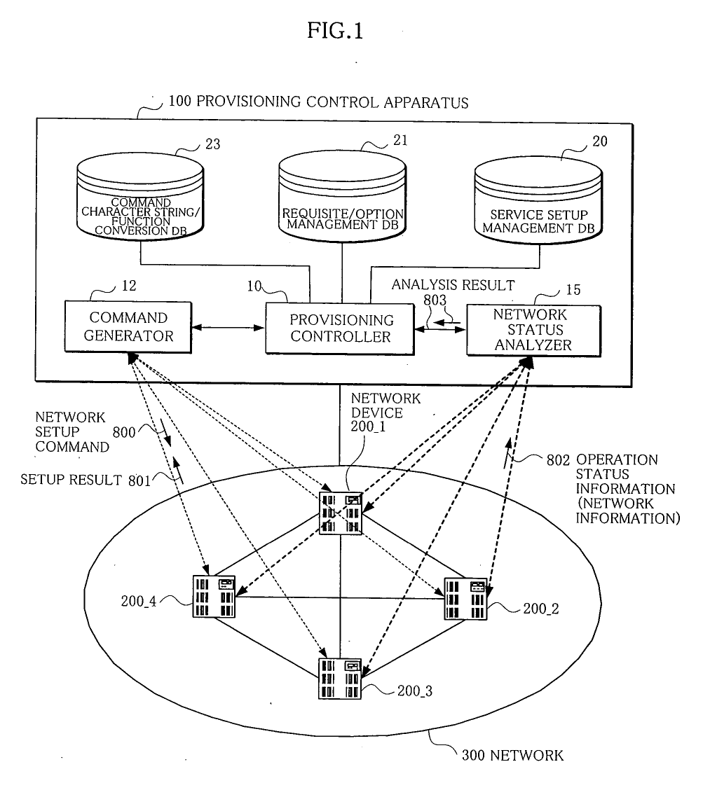

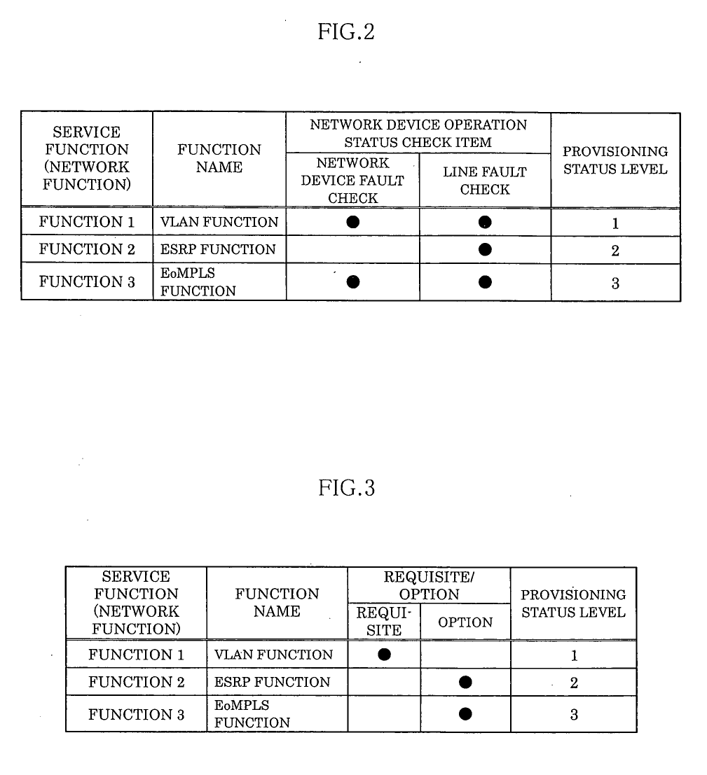

### DESCRIPTION OF THE EMBODIMENTS

Embodiment of Arrangement

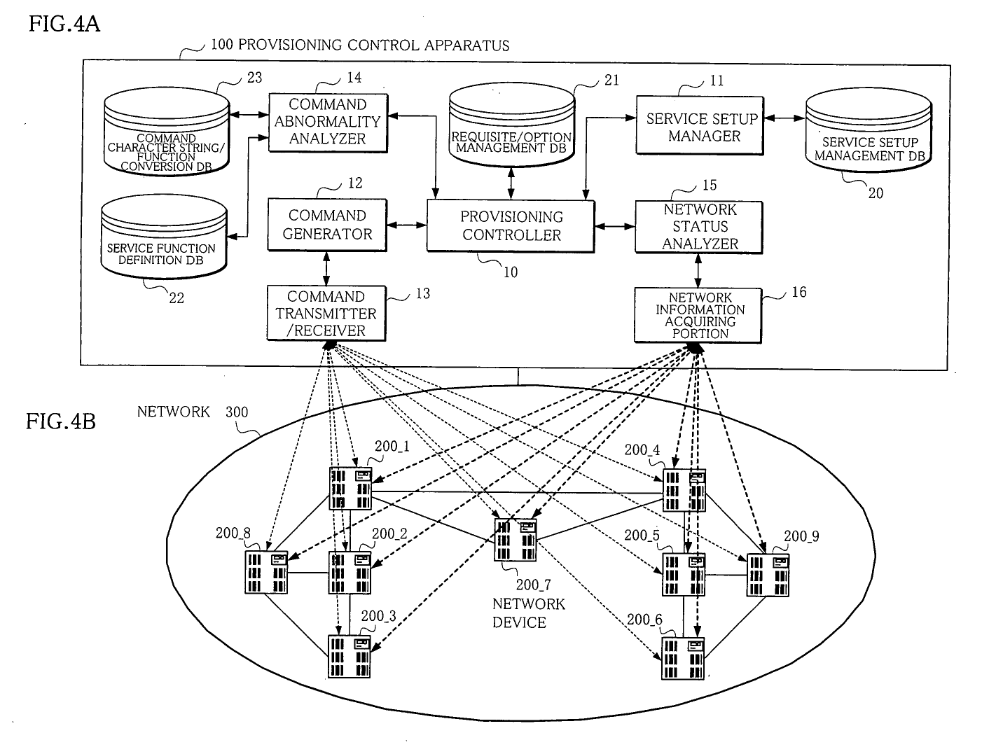

FIG. 4A shows an embodiment of an arrangement of the provisioning control apparatus 100 according to the present invention. This control apparatus 100 is composed of the provisioning controller 10, a service setup manager 11, the command generator 12, a command transmitter/receiver 13, a command abnormality analyzer 14, the network status analyzer 15, a network information acquiring portion 16, and a plurality of databases (hereinafter, occasionally abbreviated as DB).

The databases include the service setup management database 20, the requisite/option management database 21, a service function definition database 22, and the command character string/function conversion database 23.

FIG. 4B shows the network 300 managed by the provisioning control apparatus 100. The network 300 is composed of network devices 200_1-200_9 (hereinafter, occasionally represented by a reference numeral 200). These network devices 200 are respectively connected to the command transmitter/receiver 13 and the network information acquiring portion 16 of the provisioning control apparatus 100.

Following operation embodiments (1)-(4) show examples where a network operator constructs a “wide-area VLAN service (network architecture)” on the network 300 according to a customer's request.

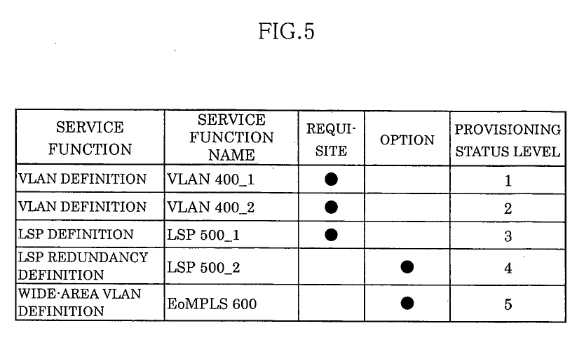

FIG. 5 shows an example of a wide-area VLAN service definition. This wide-area VLAN service is composed of a plurality of service functions, i.e. service function names=VLAN 400_1, VLAN 400_2, LSP 500_1, LSP 500_2, EoMPLS 600. The VLAN's 400_1 and 400_2 are defined by a VLAN definition, the LSP 500_1 is defined by an LSP definition, the LSP 500_2 is defined by an LSP redundancy definition, and the EoMPLS 600 is defined by a wide-area VLAN definition. The provisioning order of the service functions of the wide-area VLAN service begins from the top of the list, i.e. in the order of VLAN 400_1, VLAN 400_2, . . . , and EoMPLS 600.

Also, either “requisite” or “option” is set up in each service function. In the “wide-area VLAN service”, the VLAN 400_1, the VLAN 400_2, and the LSP 500_1 are “requisite”, and the LSP 500_2 and the EoMPLS 600 are “option”.

A “requisite service function” means that the service is requisite to render a wide-area VLAN service, and an “optional service function” means that the service is not always requisite to render the wide-area VLAN service.

Also, Nos. “1”-“5” indicating the provisioning status level are added to the service functions.

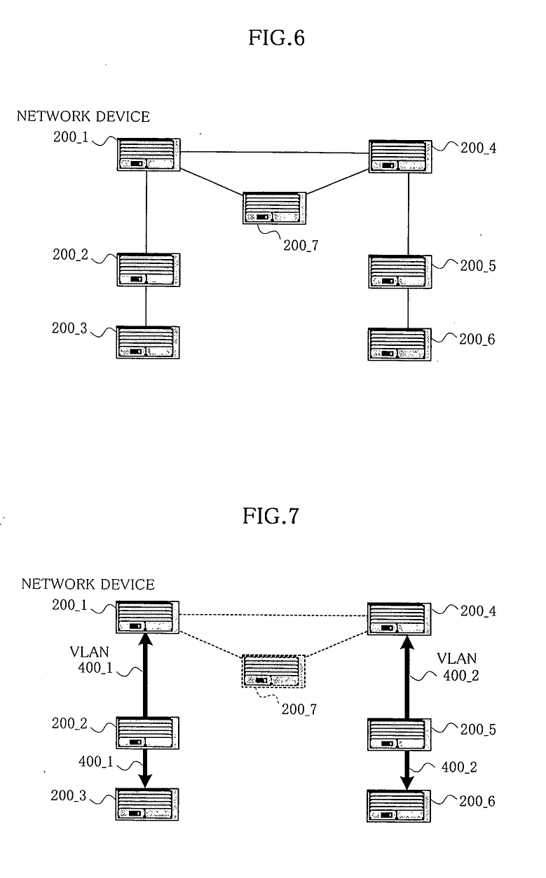

FIG. 6 shows a network arrangement (1) necessary for rendering the wide-area LAN service. This network arrangement (1) is composed of the network devices 200_1-200_7 selected from among the network devices 200_1-200_9 of the network 300 shown in FIG. 4B. These network devices 200 require the provisioning (setup) for the wide-area LAN service by the provisioning control apparatus 100.

FIG. 7 shows a network arrangement (2). This network arrangement (2) shows requisite VLAN functions of which provisioning (setup) the provisioning controller apparatus 100 has to firstly perform in order to render the wide-area VLAN service in the network arrangement (1).

The VLAN functions are the VLAN 400_1 constructed on the network devices 200_1-200_3, and the VLAN 400_2 constructed on the network devices 200_4-200_6.

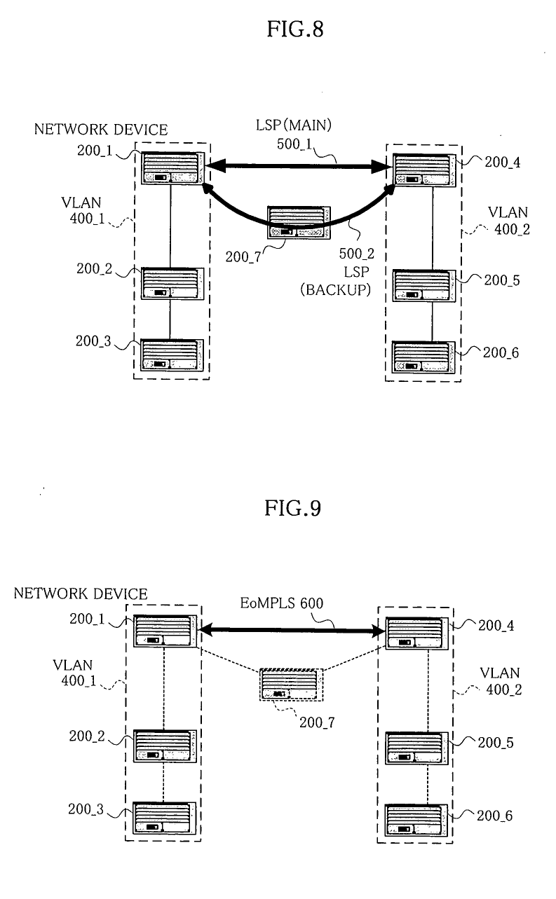

FIG. 8 shows a network arrangement (3). This network arrangement (3) shows a requisite LSP function and the optional redundancy LSP function of which provisioning the provisioning control apparatus 100 has to secondly perform in order to render the wide-area VLAN service in the network arrangement (2).

These LSP functions are for connecting the VLAN 400_1 and the VLAN 400_2, namely the main (requisite) LSP 500_1 and the backup (optional or redundancy) LSP 500_2 connecting the network devices 200_1 and 200_4.

FIG. 9 shows a network arrangement (4). This network arrangement (4) shows an EoMPLS function of which provisioning the provisioning controller apparatus 100 has to lastly perform in order to render the wide-area VLAN service in the network arrangement (3). This EoMPLS function is for connecting the VLAN 400_1 and the VLAN 400_2, and the EoMPLS 600 constructed on the network devices 200_1, 200_4, and 200_7.

Description of Databases 20-23

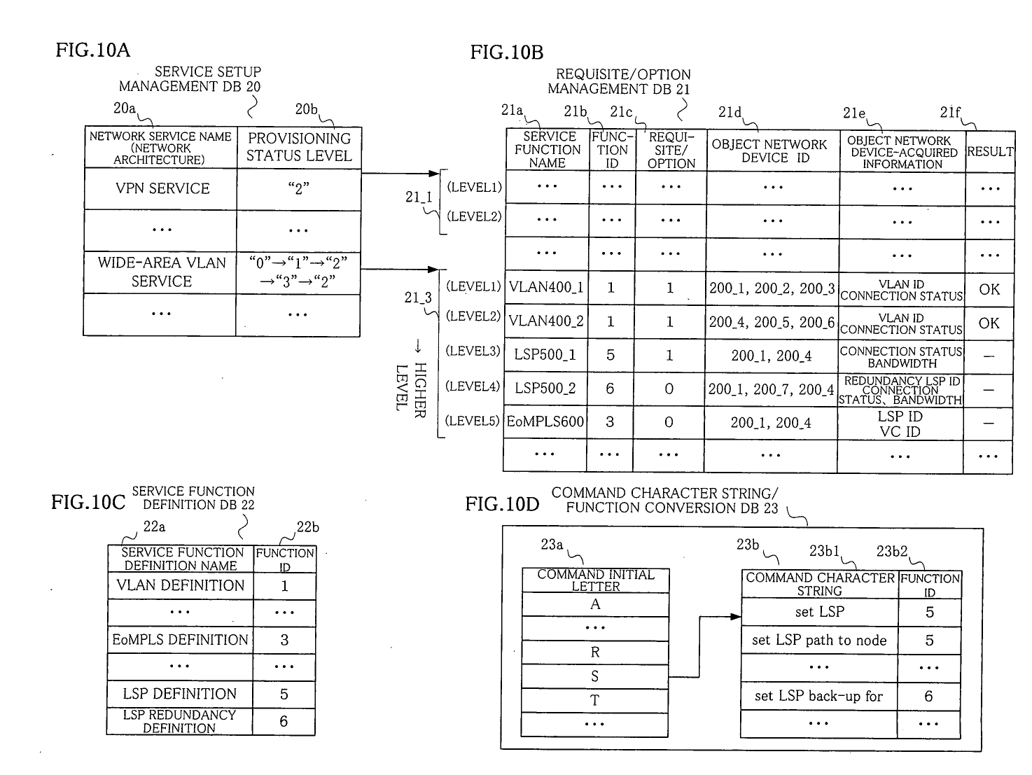

FIGS. 10A-10D respectively show arrangements of the service setup management DB 20, the requisite/option management DB 21, the service function definition DB 22, and the command character string/function conversion DB 23 shown in FIG. 4A. Data necessary for performing the above-mentioned wide-area VLAN service are set up in the databases 20-23. The databases 20-23 will now be described.

Service setup management DB 20: A “network service name (network arrangement) 20a” rendered or having been rendered on the network (e.g. VPN service, the above-mentioned wide-area VLAN service, etc.) is registered. Furthermore, a “provisioning status level 20b” indicating a level of a present provisioning status in the service of the network service name 20a is also registered. This provisioning status level is incremented by “1” when the provisioning for each service function succeeds, and is decremented by “1” when it has failed.

Requisite/option management DB 21: The database 21 is one indicating a correspondence between a service function name 21a, a function ID 21b which is an identifier (ID) of this function, a requisite/option 21c (“1”=requisite, “0”=option) indicating whether the service function is “requisite” or “optional” for performing a network service, an “object network device ID 21d” related to each service function, an “object network device-acquired information 21e” which is information acquired from an object network device, and a “result indicating a setup result 21f” (success=“OK”, failure=“NG”).

This database 21 is composed of requisite/option management databases 21_1, . . . , 21_3, . . . corresponding to each service (VPN service, . . . , wide-area VLAN service, . . . etc.) indicated in the “network service name 20a” of the database 20 (see arrows between FIGS. 10A and 10B).

The database 21_3, for example, is one corresponding to the “wide-area VLAN service” shown in FIG. 5, and is composed of the service functions of the function name 21a=“VLAN 400_1”, “VLAN 400_2”, “LSP 500_1”, “LSP 500_2”, and EoMPLS 600.

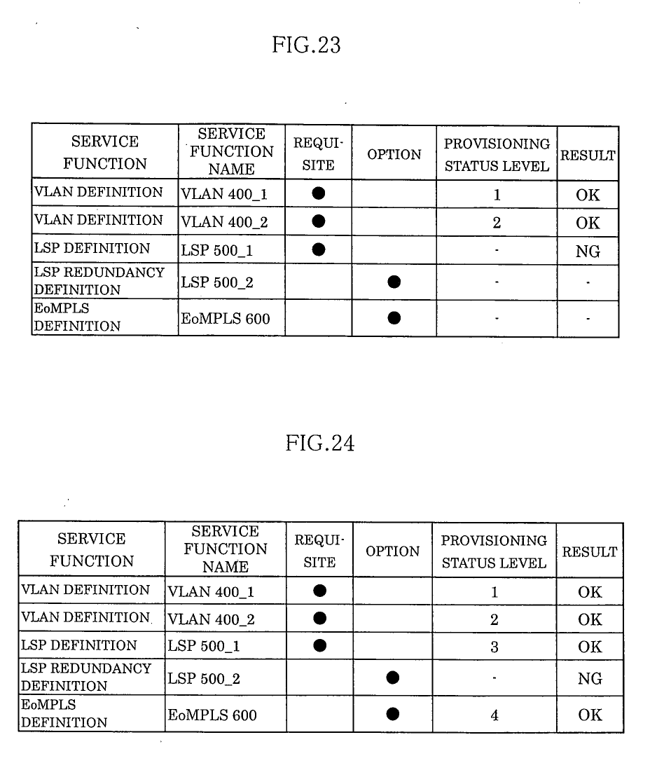

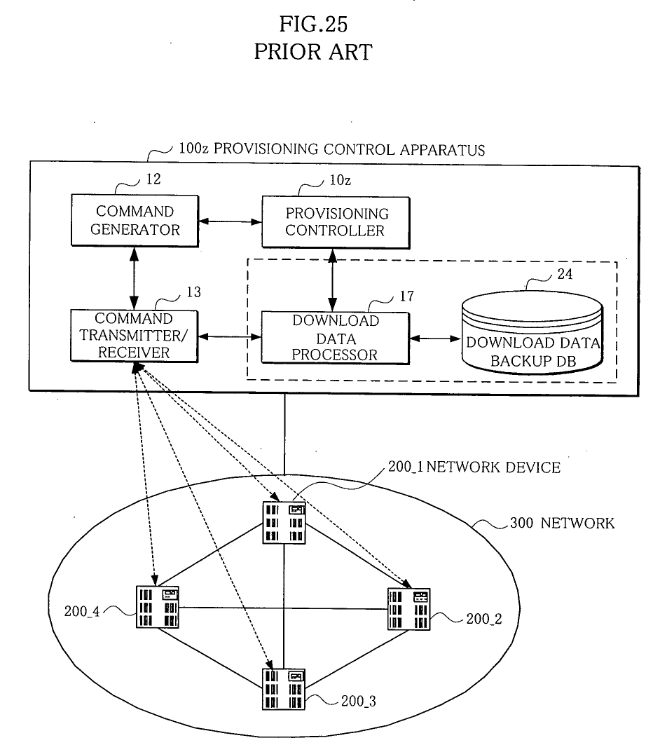

It is to be noted that the requisite/option management DB 21 can be connected to the above-mentioned service setup management DB 20 with pointers (see arrows between FIGS. 10A and 10B), and the requisite/option management DB 21 and the service setup management DB 20 can be regarded as a single database. Accordingly, by accessing the service setup management DB 20, as shown in FIGS. 23 and 24 described later, it is possible to access the requisite/option management DB 21 and to read the data.

Service function definition DB 22: This is a database indicating a correspondence between a “service function definition name 22a” which defines the service function by a command character string or a command character string group and its “service function ID 22b”.

Command character string/function conversion DB 23: The command character string or the command character string group is converted into a corresponding service function ID, i.e. an ID of a service function of which provisioning is performed by the command character string, etc.

The command character string/function conversion DB 23 is composed of a database 23b and a database 23a. The database 23b is composed of a command character string 23b1 in which the command initial letter is arranged in the alphabetical order and a service function ID 23b2 corresponding thereto.

The database 23a indicates a position in which the first of the command character strings having the same initial letter (alphabet) in the command character string 23b1 of the database 23b is arranged.

In FIG. 10D, the position of “set LSP” at the head of the command character strings “set LSP”, “set LSP path to node”, . . . , “set LSP back-up for” . . . whose initial letters of the command character string=“s” is indicated by the database 23a (see arrow between databases 23a and 23b).

Description of Operation in Each Function Portion

The functions of the command transmitter/receiver 13, the provisioning controller 10, the service setup manager 11, the command generator 12, the command abnormality analyzer 14, the network status analyzer 15, and the network information acquiring portion 16 shown in FIG. 4A will now be described referring to the above-mentioned databases 20-23 as required.

Provisioning controller 10: The provisioning controller 10 demands the command generation, from the command generator 12, for performing provisioning required for rendering e.g. the wide-area VLAN service. Also, the provisioning controller 10 retrieves requisite/option of the service function of which provisioning has failed from the requisite/option management database 21, and requests the network status analyzer 15 to analyze a provisioning failure factor based on a retrieval result or the like (failure factor analysis request). Furthermore, the provisioning controller 10 investigates an effect development of the service function on which a returned investigation result (failure factor) exerts an effect, and determines whether or not the provisioning process should be continued. If the determination result indicates an abort of the provisioning process, the provisioning controller 10 performs, together with the network status analyzer 15, switchback processing for the service function of the network service set up before the provisioning has failed.

Service setup manager 11: This service setup manager 11 manages the service function realized by the provisioning per network service, e.g. per wide-area VLAN service, and VPN service, as the provisioning status level with the service setup management database 20 (see FIG. 10A).

Command generator 12: When receiving a command generation demand for realizing a predetermined network service (network architecture (e.g. wide-area VLAN service: composed of a series of service functions indicated in the DB 21_3 included in the DB 21 of FIG. 10B)) from the provisioning controller 10, the command generator 12 generates a network control command (command character string or command character string group; hereinafter, occasionally simply represented by command character string) for realizing a series of service functions for the network device 200, provides a command issue demand including this command character string to the command transmitter/receiver 13, and requests the provisioning (setup) of the network device 200 with the command character string.

Command transmitter/receiver 13: This command transmitter/receiver 13 is provided with a CLI (Command Line Interface) or the like, and performs provisioning of the network device 200 with the command issue demand (command character string) received from the command generator 12, and transfers the setup result received from the network device 200 to the command generator 12 which is a request source by using the CLI.

Command abnormality analyzer 14: This command abnormality analyzer 14 retrieves the command character string/function conversion database 23, and converts the command character string of which the provisioning has failed into the service function ID.

Network status analyzer 15: When receiving the failure factor analysis request (service function ID, provisioning status level, etc.) from the provisioning controller 10, the network status analyzer 15 analyzes the network information (operation status information) to be acquired from the network device 200 based on the ID of the service function and the provisioning status level at which provisioning has failed, etc., and demands the acquisition of the information from the network information acquiring portion 16.

Also, the network status analyzer 15 analyzes the failure factor of the provisioning process from the operation status information acquired of the network device, and provides the failure factor which is the analysis result to the provisioning controller 10.

Network information acquiring portion 16: This network information acquiring portion 16 acquires the operation status information of the network device 200 based on the instructions from the network status analyzer 15, e.g. through the SNMP or the like.

Operation Embodiment (1) in Case of Basic Operation Procedure:

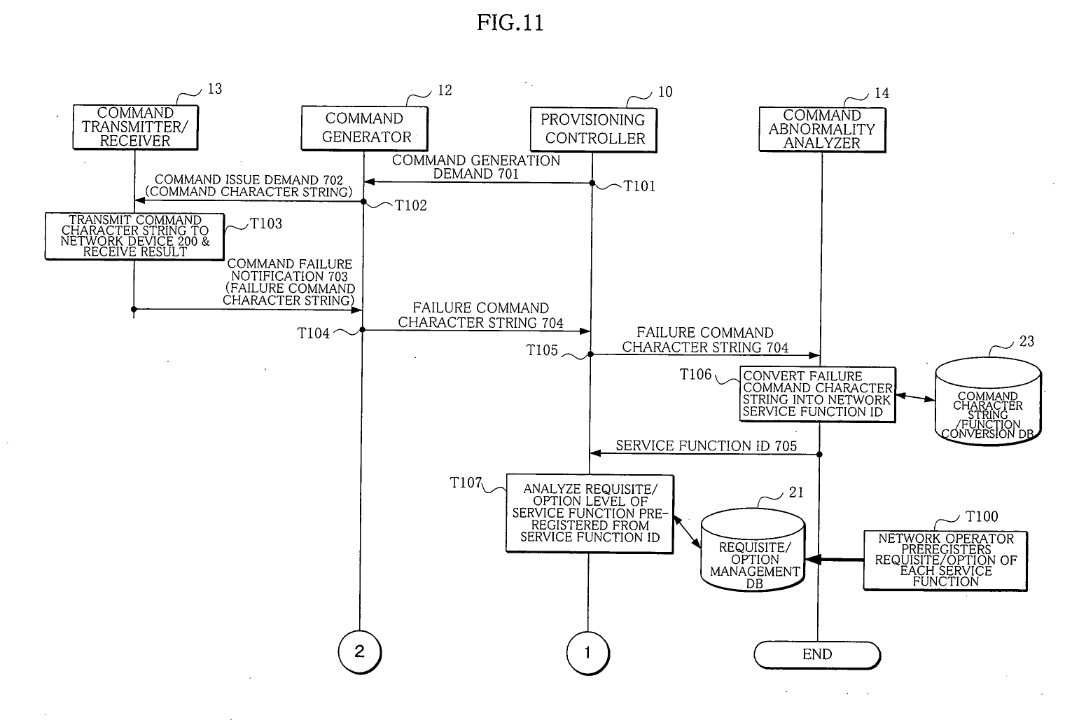

FIG. 11 shows a basic operation procedure example of performing provisioning of the network device 200, especially a requisite/option analyzing procedure, based on the instructions of the provisioning controller 10 in the provisioning control apparatus 100 of the present invention provided with the above-mentioned functions. This example will now be described.

Step T100: A network operator preregisters e.g. the “wide-area VLAN service” in the service setup management DB 20 and the requisite/option management DB 21. For example, in the requisite/option management DB 21, the service function composing the “wide-area VLAN service” is registered in the service function name 21a, whether each service function is requisite or optional is registered in the requisite/option 21c, and the object network device 200 is registered in the object network device ID 21d (see FIG. 10B).

Step T101: The provisioning controller 10 makes a command generation demand 701 for setting up the network device 200 to the command generator 12 in order to perform the provisioning of the “wide-area VLAN service” referring to the requisite/option management DB 21.

Step T102: After generating the command character string issued for the network device 200, the command generator 12 provides a command issue demand 702 including the command character string and designating a predetermined network device 200 to the command transmitter/receiver 13.

Step T103: The command transmitter/receiver 13 having received the command issue demand 702 issues a command (command character string) by using the CLI or the like for the designated network device 200 (not shown). Furthermore, when the command transmitter/receiver 13 receives an execution result of the command from the network device 200 (not shown), and this command execution result indicates a failure, the command transmitter/receiver 13 returns a command failure notification 703 including a failure command character string to the command generator 12.

Step T104: The command generator 12 transfers the failure command character string 704 included in the notification 703 to the provisioning controller 10.

Step T105: The provisioning controller 10 provides the received failure command character string 704 to the command abnormality analyzer 14.

Step T106: The command abnormality analyzer 14 accesses the command character string/function conversion database 23 (see FIG. 10D), converts the failure command character string 704 into an identifier (ID) 705 of the service function composing the network service, and returns the service function ID 705 to the provisioning controller 10.

Step T107: The provisioning controller 10 retrieves the function name corresponding to the failed service function ID 705 and analyzes whether the function is requisite or optional from the requisite/option management database 21 (see FIG. 10B).

Then, the provisioning controller 10 switches back the command set up in each network device 200 in order to stop the network service construction, when the failed service function is requisite. When it is optional, the provisioning controller 10 switches back e.g. only the failed command and renders possible services at that time.

It is to be noted that while only the case where the provisioning has failed is shown in FIG. 11, when the provisioning corresponding to e.g. the first VLAN 400_1 has succeeded, a command success notification is provided to the provisioning controller 10 through the command generator 12 instead of the command failure notification (failure command character string).

The provisioning controller 10 returns to step T101, and provides the command generation demand 701 of the provisioning corresponding to the subsequent VLAN 400_2 to the command generator 12. By executing steps T102 and T103, the provisioning of the VLAN 400_2 is completed. Similarly, by repeating steps T11-T103 for other service functions (LSP 500_1, LSP 500_2, and EoMPLS 600), it becomes possible to render the wide-area VLAN service.

Operation Embodiment (2) in Case Provisioning of Requisite Service Function has Failed:

This embodiment (2) shows a case where the provisioning of the requisite service function has failed in the provisioning process operation procedure of the wide-area VLAN service in the embodiment (1). Since the wide-area VLAN service can not be rendered, it is necessary to switch back the failed provisioning, and to restore the network device 200.

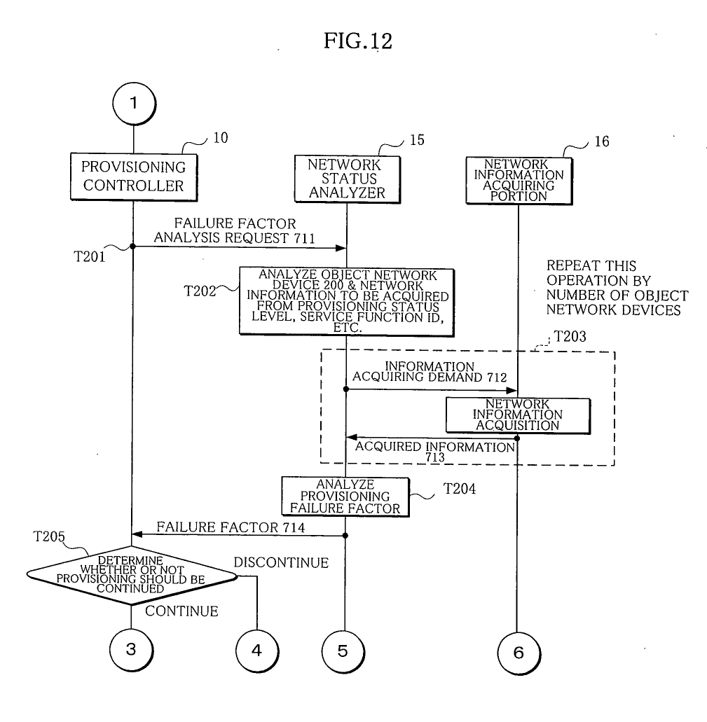

FIG. 12 shows an operation procedure of the network information (operation status information) acquisition executed after the requisite/option analysis processing shown in FIG. 11, and an operation procedure example of the analysis processing for determining whether or not the provisioning process should be continued.

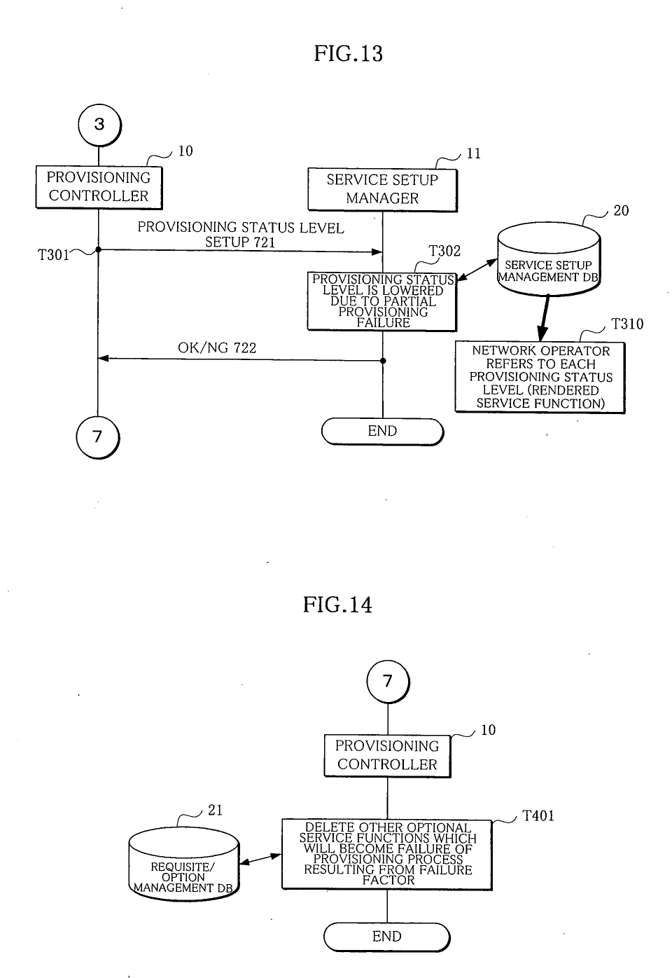

FIG. 13 shows an operation procedure example of the provisioning status level management processing in the network service.

FIG. 14 shows a procedure example of effect development processing into another provisioning.

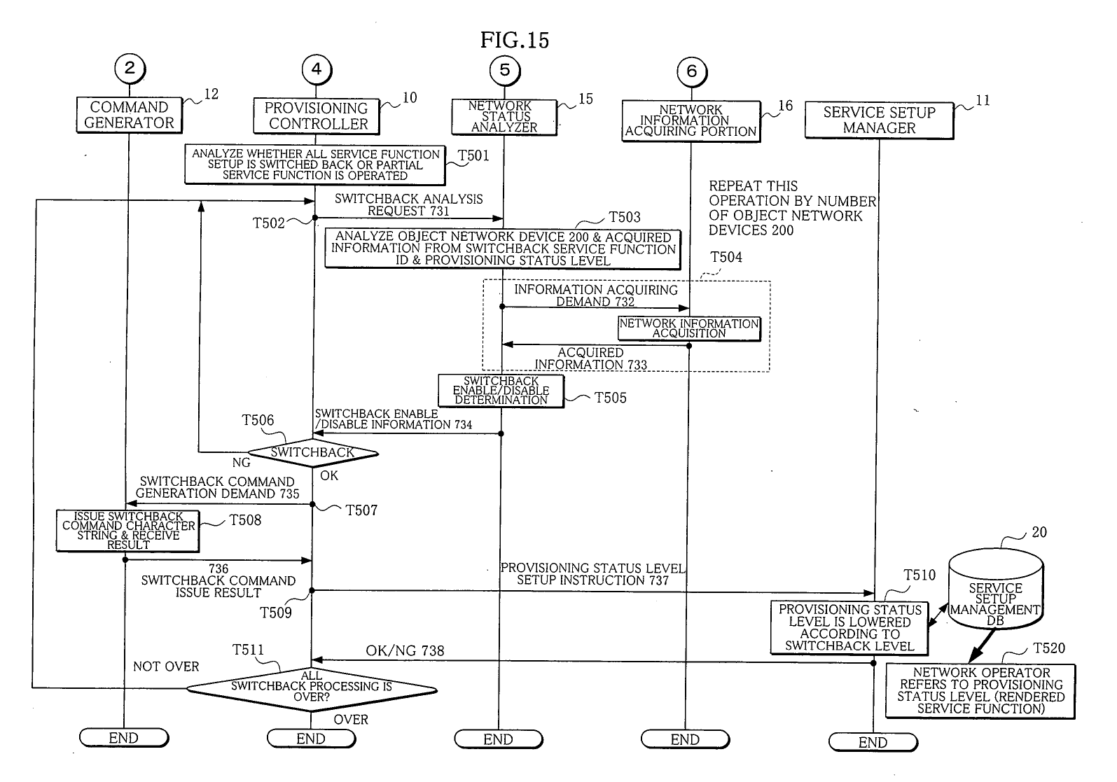

FIG. 15 shows a processing operation procedure example of the provisioning controller 10 shown in FIGS. 4A and 11, especially a switchback processing procedure example at a time of a provisioning process abort.

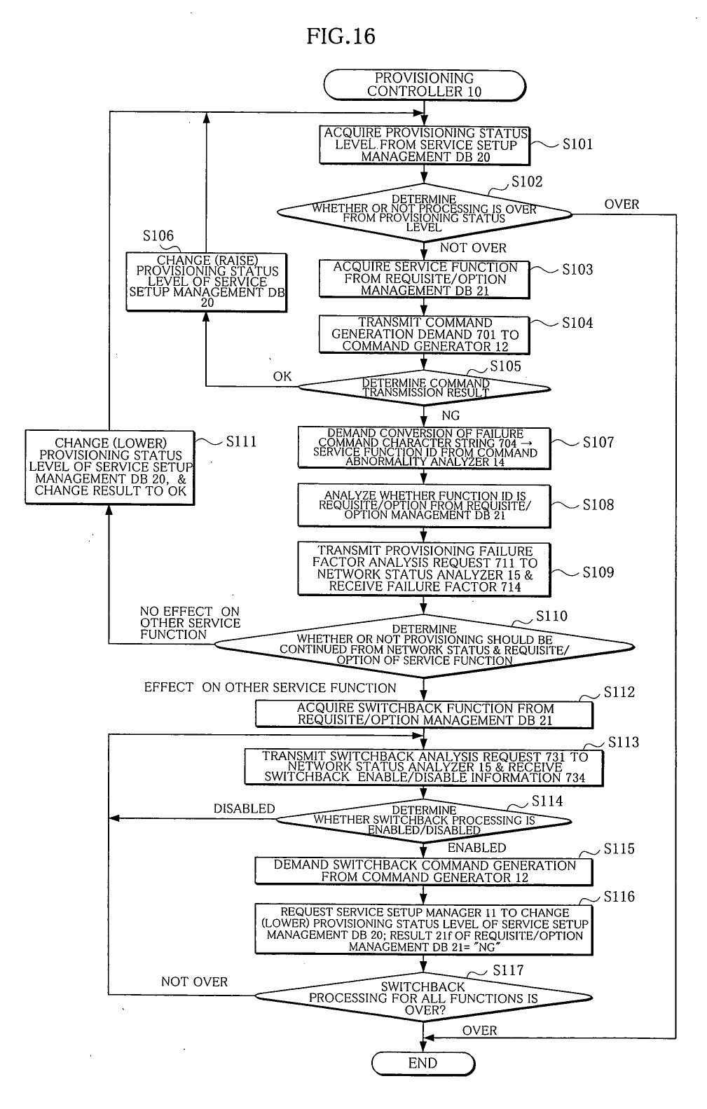

FIG. 16 shows an operation of the provisioning controller 10 in more detail including the operation procedure shown in FIG. 11.

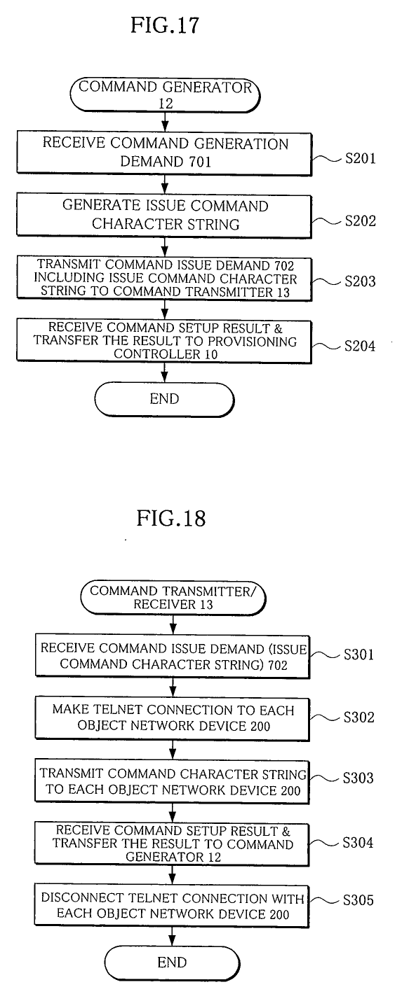

FIGS. 17-22 respectively show operation procedure examples of the command generator 12, the command transmitter/receiver 13, the service setup manager 11, the command abnormality analyzer 14, the network status analyzer 15, and the network information acquiring portion 16.

An operation procedure example of aborting the network service construction when the provisioning (setup) of the requisite service function has failed will now be described referring to FIGS. 12-22. It is to be noted that the operation procedure of the embodiment (1) will be also described in more detail.

Step S101: In FIG. 16, the provisioning controller 10 acquires the provisioning status level 20b=“0 (initial state)” corresponding to the network service name 20a=“wide-area VLAN service” from the provisioning service setup management DB 20 (see FIG. 10A).

It is to be noted that when the provisioning status level 20b=“5: processing completed level (see FIG. 5)”, the provisioning process is over.

Steps S102 and S103: Since the provisioning level is not the processing completed level=“5”, the provisioning controller 10 acquires the service function=“VLAN 400_1” of the database 21_3 (see FIG. 10b) corresponding to “level 1” of the “wide-area VLAN service”.

Step S104: The provisioning controller 10 transmits the command generation demand 701 demanding the command generation corresponding to the service function=“VLAN 400_1” to the command generator 12 (see step T101 of FIG. 11).

Steps S201-S203: In FIG. 17, the command generator 12 generates the command character string based on the received command generation demand 701, and transmits the command issue demand 702 including the command character string and the designated network device 200 to the command transmitter/receiver 13 (see step T102 of FIG. 11).

Steps S301-S303: In FIG. 18, the command transmitter/receiver 13 receives the command issue demand 702, and transmits the command character string to the network device 200 after making a telnet connection to the designated network device 200.

Steps S304 and S305: Furthermore, the command transmitter/receiver 13 receives the command setup result from the network device 200, transfers the result (e.g. the provisioning command is supposed to have succeeded) to the command generator 12 (see step T103 of FIG. 11; While this case indicates a failure notification example, success notification can be applied like the failure notification), and disconnects the telnet connection with the network device 200.

Step S204: In FIG. 17, the command generator 12 transfers the command setup result to the provisioning controller 10 (see step T104 of FIG. 11).

Step S105: In FIG. 16, the provisioning controller 10 receives the command setup result from the command generator 12, and proceeds to step S106 since the command transmission result, i.e. the VLAN definition provisioning of the VLAN 400_1 indicates success.

Step S106: The provisioning controller 10 increases the setup level of the provisioning status level 20b to “1” in the service setup management DB 20, and returns to step S101.

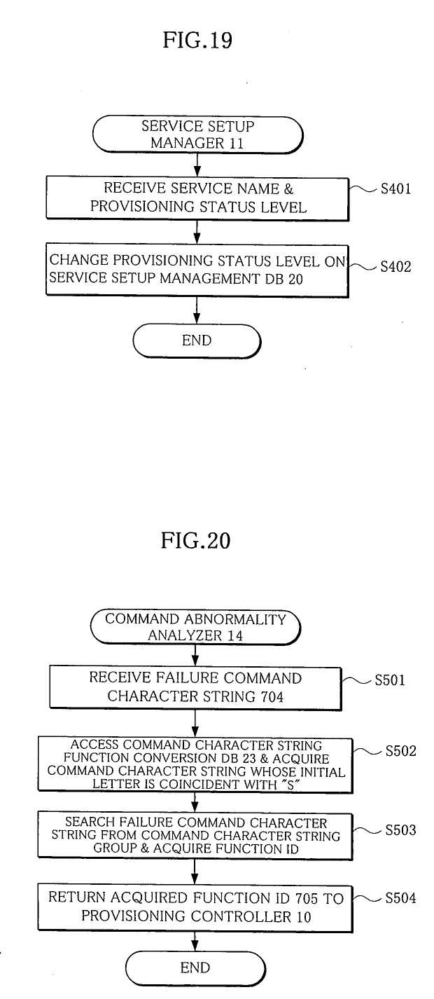

Steps S401 and S402: Namely, in FIG. 19, the service setup manager 11 receives the “service name (=wide-area VLAN service)” and the “provisioning status level” from the provisioning controller 10, and changes the provisioning status level to “1” in the service setup management DB 20.

Steps S101-S106: In FIG. 16, the provisioning controller 10 repeats steps S101-S106, whereby the VLAN definition provisioning of the VLAN 400_2 succeeds, the provisioning status level is increased to “2”, and the process returns to step S101.

Steps S101-S106: The provisioning controller 10 recognizes the subsequent provisioning is provisioning of the LSP 500_1 (see FIG. 8: LSP between the network devices 200_1 and 200_4) whose service function is at provisioning status level “3” from the requisite/option management database 21.

The provisioning controller 10 performs the command generation demand 701 for performing the LSP definition provisioning to the network devices 200_1 and 200_4 to the command generator 12.

Steps S201-S204: In FIG. 17, the command generated for the LSP setup by the command generator 12 is supposed to be e.g. “set LSP”, or “set LSP path to node 4 (LSP path setup command to node 4 (e.g. network device 200_4))”. The command generator 12 provides the command issue demand 702 including an LSP setting command to the command transmitter/receiver 13 in order to set up the LSP500_1 in the network devices 200_1.

Steps S301-S305: In FIG. 18, the command transmitter/receiver 13 connects to the network device 200_1 with telnet, and transmits the LSP setup command received from the command generator 12.

The command transmitter/receiver 13 is supposed to receive, from the network device 200_1, a fact that the LSP setup command “set LSP path to node 4” has failed.

The command transmitter/receiver 13 returns the failure command character string “set LSP path to node 4” which has failed in the LSP provisioning to the provisioning controller 10 through the command generator 12 (see steps T103 and T104 of FIG. 11).

Steps S105 and S107: In FIG. 16, the provisioning controller 10 inquires the service function corresponding to the character string of the provisioning failure=“set LSP path to node 4” of the command abnormality analyzer 14. Namely, the provisioning controller 10 transmits the failure command character string 704 to the command abnormality analyzer 14 (see step T105 of FIG. 11).

Steps S501-S504: In FIG. 20, the command abnormality analyzer 14 accesses the command character string/function conversion database 23 (see FIG. 10D) with the received failure command character string 704 as key information. At this time, the command abnormality analyzer 14 firstly retrieves an initial letter “S” of the command character string in the database 23a, further acquires the command character string group starting with “S” in the database 23b indicated by “S”, retrieves the failure command character string “set LSP path to node 4” from the command character string group, acquires the service function ID=“5 (LSP definition function)” corresponding to the command character string with the utmost character string coincidence, and returns the acquired service function ID=“5” to the provisioning controller 10 (see step T106 of FIG. 11).

Step S108: In FIG. 16, the provisioning controller 10 accesses the requisite/option management DB 21 (see FIG. 10B) with the received ID=“5 (LSP definition function)” of the service function of which provisioning has failed and the network service name=wide-area VLAN service as key information, and analyzes that the service function ID=“5” is “requisite”.

Step S109: Based on this analysis result, the provisioning controller 10 further refers to the requisite/option management database 21, and recognizes that the object network devices 200 which define the LSP 500_1 are network devices 200_1 and 200_4, and that the object network device-acquired information 21e concerning the LSP definition is “connection status” and “bandwidth setup status” between devices.

The provisioning controller 10 requests the network status analyzer 15 to analyze the provisioning failure factor. Namely, the provisioning controller 10 transmits the failure factor analysis request 711 including the provisioning status, the service function name, etc. (e.g. “during LSP definition setup with respect to the network devices 200_1 and 200_4”, service function ID=“5”, and “collection request of “connection status” and “bandwidth setup status” between devices with respect to the object network devices 200_1 and 200_4”) to the network status analyzer 15 (see step T201 of FIG. 12).

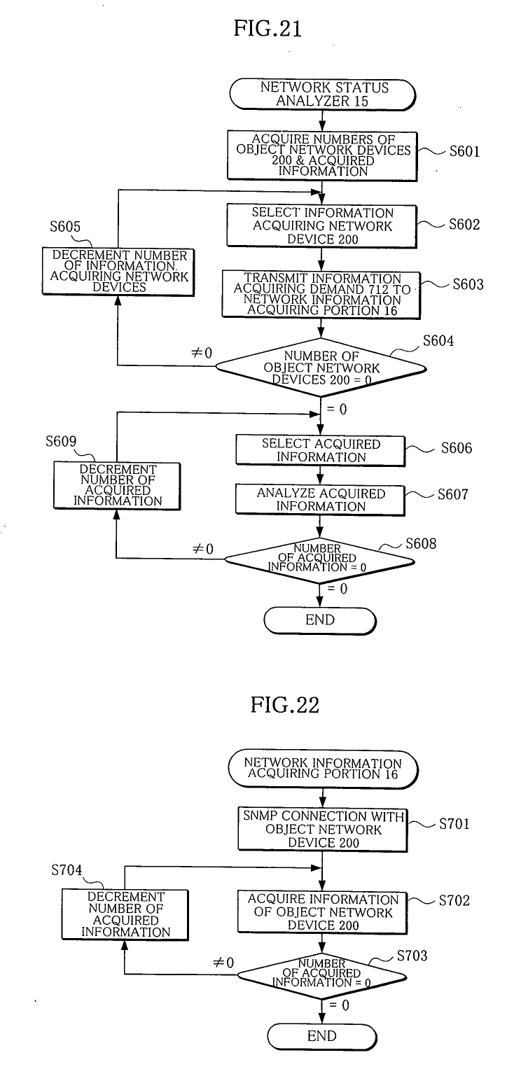

Step S601: In FIG. 21, the network status analyzer 15 having received the failure factor analysis request 711 recognizes that the connection status and the bandwidth setup between the network devices 200_1 and 200_4 which are information concerning the LSP are information to be collected for the network devices 200_1 and 200_4 concerning the LSP definition of which provisioning has failed.

Also, the network status analyzer 15 narrows down the object network devices 200 from which the network information is to be acquired, as well as information to be acquired, and determines the numbers of the network devices and acquired information (see step T202 of FIG. 12).

Steps S602-S605: Furthermore, the network status analyzer 15 provides the information acquiring request 712 which designates the object network devices and the acquired information to the network information acquiring portion 16 (see step T203 of FIG. 12). This information acquiring request 712 is repeated by the same number of times as the object network devices to be provided to the network information acquiring portion 16.

Steps S701-S704: In FIG. 22, the information acquiring portion 16 having received the information acquiring request 712 accesses the object network device 200 by a communication enabling method, e.g. the SNMP connection method. The information acquiring portion 16 acquires (collects) the information of the object network devices 200 by the number of acquired information as the acquired information 713 to be returned to the network status analyzer 15 (see step T203 of FIG. 12).

Steps S606-S609: In FIG. 21, the network status analyzer 15 receives the acquired information 713 for the object network devices, i.e. “the connection status and the bandwidth setup status for the network device 200_4” as the acquired information for the network device 200_1 and “the connection status and the bandwidth setup status for the network device 200_1” as the acquired information for the network device 200_4, and analyzes the acquired information of all of the object network devices 200.

For example, the network status analyzer 15 analyzes that a connection bandwidth shortage to the network device 200_1 on the network device 200_4 side is a provisioning failure factor, and returns a failure factor 714 of an LSP definition bandwidth shortage to the provisioning controller 10 (see step T204 of FIG. 12).

Step S110: In FIG. 16, the provisioning controller 10 having received the failure factor 714 recognizes that the provisioning failure factor is the LSP definition bandwidth shortage, and determines that the provisioning process should not be continued in consideration of a requisite function of the LSP 500_1 (LSP definition function) and an LSP setup bandwidth shortage between the network devices 200_1 and 200_4 (see step T205 of FIG. 12).

Step S112: The provisioning controller 10 acquires a service function to be switched back referring to the requisite/option management DB.

Namely, the provisioning controller 10 accesses the service setup management DB 20 with the network service name=“wide-area VLAN service”, recognizes the provisioning status level=“2”, and accesses the requisite/option management database 21 corresponding to the “wide-area VLAN service” with the provisioning status level=“2”, thereby recognizing that the service functions to be switched back are VLAN's 400_1 and 400_2, the object network devices 200 of the VLAN 400_1 are network devices 200_1-200_3, the object network devices 200 of the VLAN 400_2 are network devices 200_4-200_6, and the network acquired information concerning the VLAN definition is “VLAN ID” and “connection status” between the devices composing the VLAN.

Step T501: In FIG. 15, the provisioning controller 10 analyzes whether to delete (switch back) the setup in the service function from all of the network devices 200 concerned in the service function composing the network services of which provisioning has failed, and whether to deactivate the service function or to deactivate the service function only for the object network devices 200 in which the provisioning failure has been detected.

Step T502: Furthermore, the provisioning controller 10 provides a switchback analysis request 731 including the provisioning status level and the switchback service function name to the network status analyzer 15.

Step T503: The network status analyzer 15 having received the switchback analysis request 731 discriminates the network device 200 which has detected the provisioning failure and another network device 200 which composes the network service at the time of the failure based on the provisioning status level, and narrows down the object network devices 200 from which the network information is collected. In parallel, the information to be acquired from the object network devices 200 is narrowed down based on the switchback service function name.

The network status analyzer 15 provides an information acquiring demand 732 including the object network device 200 and the information to be acquired to the network information acquiring portion 16.

Namely, the network status analyzer 15 analyzes whether or not the switchback processing concerning the VLAN definition is enabled for the network devices 200_1-200_3 composing the VLAN 400_1 in order to analyze whether or not the switchback processing can be performed to the VLAN 400_1. Namely, the network status analyzer 15 provides, to the network information acquiring portion 16, the information acquiring demand 732 inquiring the VLAN ID that is information concerning the VLAN definition and the connection status between the network devices 200 in the order of the network devices 200_1-200_3.

Step T504: The network information acquiring portion 16 having received the information acquiring demand 732 accesses the designated network devices 200 by the communication enabling method, and acquires the designated information. This processing is repeated as many times as the number of the designated object network devices 200.

After all of the information has been acquired, the network information acquiring portion 16 returns acquired information 733 to the network status analyzer.

Step T505: The network status analyzer 15 determines whether or not the switchback processing to the switchback service function name inputted from the provisioning controller 10 is enabled based on the acquired information 733, and returns switchback enable/disable information 734 to the provisioning controller 10.

Namely, the network status analyzer 15 checks the VLAN ID that is the VLAN definition information of the network devices 200_1-200_3 and connection status between the network devices 200, and determines whether or not the switchback processing is enabled. The switchback processing concerning the VLAN400_1 is determined to be enabled, and the switchback enable/disable information 734 indicating that the switchback processing is enabled is returned to the provisioning controller 10.

Steps T506-T508: When the switchback enable/disable information 734 indicates “enable”, the provisioning controller 10 provides a switchback command generation demand 735 to the command generator 12 in order to generate a command for the concerned switchback service function.

The command generator 12 having received the switchback command generation demand 735 generates the switchback command character string provided to the network device 200, and then performs the switchback command issue demand for the network device to the command transmitter/receiver 13 (not shown).

The command transmitter/receiver 13 having received the switchback command issue demand issues the switchback command to the object network devices 200 by using the CLI or the like, and receives the command execution result (not shown). This command execution result is transferred to the provisioning controller 10 through the command generator 12 as a switchback command issue result 736.

Step T509: When the switchback command issue result 736 indicates “success”, the provisioning controller 10 provides a provisioning status level setup instruction 737 to the service setup manager 11 in order to lower the provisioning status level concerning the switchback service function.

Namely, since the switchback enable/disable information 734 indicates “switchback enable” at step S114 of FIG. 16, the provisioning controller 10 transmits the switchback command generation demand 735 to the command generator 12. The command generator 12 having received the demand 735 provides the switchback command character string of the VLAN400_1 to the command transmitter/receiver 13 in the network devices 200_1-200_3, subsequently. The command transmitter/receiver 13 provides the command character string to the designated network devices 200. Furthermore, the switchback command issue result 736 from the network devices 200 is returned to the provisioning controller 10 through the command transmitter/receiver 13 and the command generator 12.

Step T510: The service setup manager 11 having received the provisioning status level accesses the service setup management database 20, changes the provisioning status level, and returns a change result (OK/NG) 738 to the provisioning controller 10.

Step T511: The provisioning controller 10 having received the OK/NG 738 determines whether or not the processing concerning all of the switchback service functions is over. If the switchback processing for all of the functions is over, the provisioning process is aborted, and the routine ends.

Namely, when the switchback command issue result 736 indicates “over” at steps S116-S117 of FIG. 16, the provisioning controller 10 requests the service setup manager 11 to lower the provisioning status level to “1” of which network service name=“wide-area VLAN service”, and changes the result 21f to “NG” of which service function name 21a is the VLAN 400_1 in the requisite/option management DB 21.

Furthermore, in FIG. 16, the provisioning controller 10 repeats steps S113-S117, performs the switchback to the service function=“VLAN 400_2”, i.e. the switchback to the VLAN 400_2 definition with respect to the network devices 200_4-200_6, then changes the provisioning status level to “0” of the network service name in the service setup management database 20=“wide-area VLAN service”, and the routine ends.

Step T506: On the other hand, when the switchback enable/disable information 734 indicates “disable”, the provisioning controller 10 returns to step T502 and performs determining whether the switchback processing of the subsequent service function composing the network service is enabled/disabled.

Thus, the provisioning of the wide-area VLAN service has failed, the wide-area VLAN service can not be performed, and the provisioning of each network device 200 is switched back to the wide-area VLAN service before the provisioning.

Since the provisioning status level of the wide-area VLAN service=“0”, the network operator can confirm that the wide-area VLAN service is not rendered.

It is to be noted that in the embodiment (2), the requisite VLAN's 400_1 and 400_2 which have succeeded in the provisioning are also switched back while wide-area VLAN services are not rendered thereto. However, it is possible to perform only the service of the VLAN 400_1 or 400_2 without switching back the VLAN's 400_1 and 400_2 which have succeeded in the provisioning.

FIG. 23 shows the provisioning status level of the wide-area VLAN service at which service functions only of the VLAN's 400_1 and 400_2 are rendered. The provisioning status level=“2”, the result of the VLAN's 400_1 and 400_2=“OK”, and the result of the LSP 500_1=“NG”.

Operation Embodiment (3) in Case Provisioning of Optional Service Function has Failed:

In this embodiment (3), the wide-area VLAN service shown in FIG. 5 is defined in the same way as the embodiment (2), the provisioning process for realizing the wide-area VLAN service is performed, and provisioning of the service function=VLAN's 400_1 and 400_2 succeeds. Different from the embodiment (2), while the provisioning of the subsequent requisite “LSP 500_1 (LSP definition)” succeeds, the provisioning of the subsequent optional “LSP 500_2 (LSP redundancy definition)” fails.

Also, since the failed provisioning is optional in the embodiment (3), it is investigated and analyzed that the provisioning failure of the subsequent service function=“EoMPLS 600 (wide-area VLAN definition)” does not occur by the same factor with the failure factor of the “LSP 500_2”, and the provisioning of the “wide-area VLAN definition” is continued.

The operation procedure example will now be described. It is to be noted that descriptions of detailed operation procedure example at each step shown in the operation embodiment (2) are occasionally omitted.

Steps S101-S106: In FIG. 16, the provisioning controller 10 repeats steps S101-S106 three times, performs the provisioning of service functions=“VLAN 400_1”, “VLAN 400_2”, and “LSP 500_1” successfully, and returns to step S101.

Steps S101-S106: Furthermore, the provisioning controller 10 executes the provisioning of the service function=“LSP 500_2”, in which the processing fails.

Namely, the provisioning controller 10 performs the command generation demand 701 to the command generator 12 for performing the LSP redundancy definition provisioning to the network devices 200_1, and 200_4, and 200_7, for the provisioning of the LSP 500_2 which is the service function of the provisioning status level=“4” from the requisite/option management DB 21 (see step T101 of FIG. 11).

The command generator 12 generates a redundancy LSP setup command “set LSP back-up for LSP 500_2”.

The command generator 12 performs the command issue demand 702 to the command transmitter/receiver 13 in order to set up the command to the network device 200_1 (see step T102 of FIG. 11). The command transmitter/receiver 13 is connected to the network device 200_1 with the telnet, and transmits the setup command having received from the command generator 12.

At this time the command transmitter/receiver 13 is supposed to receive the command failure notification 703 indicating that the LSP setup command “set LSP back-up for LSP 500_2” has failed, from the network device 200_1 (see step T103 of FIG. 11).

The command transmitter/receiver 13 returns the command character string “set LSP back-up for LSP 500_2” indicated in the command failure notification 703 to the provisioning controller 10 through the command generator 12.

Steps S107-S109: In the same way as the case where the provisioning of the service function=“LSP 500_1” has failed in the embodiment (2), the provisioning controller 10 converts the “failure command character string” into the “service function ID”, analyzes that the “LSP 500_2” is optional, and requests the analysis request 711 of the provisioning failure factor from the network status analyzer 15 (see FIG. 12).

Namely, the provisioning controller 10 inquires the service function ID to be realized by the provisioning failure character string “set LSP back-up for LSP 500_2” of the command abnormality analyzer 14. The command abnormality analyzer 14 accesses the command character string/function conversion DB 23 (see FIG. 10D) with the inputted failure character string as key information, and acquires the service function ID=“6” corresponding to the failure command character string “set LSP back-up for LSP 500_2” to be returned to the provisioning controller 10.

The provisioning controller 10 recognizes that the ID of the service function of which provisioning has failed=“6”, i.e. the LSP redundancy definition function. The provisioning controller 10 accesses the requisite/option management DB 21 (see FIG. 10B) with the network service name=wide-area VLAN service, the function ID=“6” as key information, in order to determine that the LSP redundancy definition function is requisite or optional, and analyzes that the function of which provisioning has failed is “optional”.

Also, the provisioning controller 10 recognizes that the object network devices 200 which define the LSP 500_2 are network devices 200_1, 200_4, and 200_7, and the network collected information concerning the LSP redundancy definition is connection status between the devices, the bandwidth setup status, and the LSP ID of redundancy objects.

The provisioning controller 10 requests the network status analyzer 15 to analyze the failure factor. At this time, the provisioning controller 10 notifies, to the network status analyzer 15, “LSP redundancy definition is being set up to the network devices 200_1, 200_4, and 200_7” that is the recognized provisioning status level, “the service function ID=6”, and “the connection status between the object network devices 200_1, 200_4, and 200_7, the bandwidth setup status, and the LSP ID of the redundancy object are collected”.

The network status analyzer 15 performs the information collection request per network device 200 to the network information acquiring portion 16 to collect the mutual connection status between the devices required for the LSP redundancy definition for the network devices 200_1, 200_4, and 200_7, the bandwidth setup information, and the LSP ID of the redundancy object.

The network information acquiring portion 16 performs the SNMP connection to the network devices 200_1, 200_4, and 200_7. The network information acquiring portion 16 acquires the connection status for the network device 200_7 and the bandwidth setup status, and the LSP setup status of the redundancy LSP ID with respect to the network device 200_1. The network information acquiring portion 16 acquires the connection status for the network device 200_7 and the bandwidth setup status, and the LSP setup status of the redundancy LSP ID with respect to the network device 200_4. The network information acquiring portion 16 acquires the connection status for the network devices 200_1 and 200_4 and the bandwidth setup status, and the LSP setup status information of the redundancy LSP ID with respect to the network device 200_7.

The network information acquiring portion 16 returns the acquired information to the network status analyzer 15 per network devices 200_1, 200_4, and 200_7.

Furthermore, the network status analyzer 15 analyzes the acquired result returned from the network information acquiring portion 16. At this time, the network status analyzer 15 founds that the connection status to the network device 200_7 on the network device 200_4 side is a protocol fault as for the connection status which is the acquired object information, analyzes that this is a provisioning failure factor, and returns the failure factor 714 of the path fault between the network devices 200_4 and 200_7 to the provisioning controller 10 as the analysis result (see step S204 of FIG. 12).

Step S110: The provisioning controller 10 receives the failure factor 714 from the network status analyzer 15, and recognizes that the provisioning failure factor is a fault of a connection path required for the LSP redundancy definition (see step T205 of FIG. 12).

Step S110: The provisioning controller 10 determines whether or not the failure of the provisioning process has an effect on the failure of the provisioning process for the subsequent service functions. If it is determined that there is no effect, the provisioning is enabled to be continued, and provisioning for the other functions composing the service can be continued.

Step S111: The provisioning controller 10 changes (raises) the provisioning status level of the service setup management DB 20, and then returns to step S101.

Namely, in FIG. 13, the service setup manager 11 accesses the service setup management DB 20 with the network service name=“wide-area VLAN service”, and sets up the provisioning status level=“3” (steps T301-T302 of FIG. 13, or steps S401 and S402 of FIG. 19).

Also, the provisioning controller 10 changes the provisioning result 21f=“NG” concerning the LSP 500_2 of the requisite/option management DB 21.

Furthermore, in order to determine whether or not the provisioning process should be continued considering that the LSP 500_2 (LSP redundancy definition function) is “optional”, and that a connection path fault has occurred for the LSP redundancy definition between the network devices 200_4 and 200_7, the provisioning controller 10 develops an effect into subsequent service functions of the wide-area VLAN service.

The provisioning controller 10 recognizes that the function of subsequent provisioning is the EoMPLS definition of the service function ID=“3”, from the service setup management database 20 (see FIG. 10A) and the requisite/option management database 21.

Since the LSP 500_1 has already succeeded in the provisioning as the LSP definition required for the EoMPLS function, the provisioning controller 10 analyzes that the provisioning for the EoMPLS function is enabled.

Furthermore, the provisioning controller 10 analyzes that the provisioning object network devices for the EoMPLS function are the network devices 200_1 and 200_4, and the connection path fault between the network devices 200_4 and 200_7 has no effect on the provisioning process.

Based on the above-mentioned analysis result, the provisioning controller 10 determines that the continuation of provisioning for the wide-area VLAN service, i.e. provisioning of the EoMPLS function is enabled, and executes the provisioning.

Steps S101-S106: When the provisioning of the subsequent service function=“EoMPLS600” succeeds, the provisioning controller 10 increments the provisioning status level only by “1”, and then returns to step S101.

Steps S101 and S102: The provisioning controller 10 determines that the provisioning process of the wide-area VLAN service is over from the provisioning status level=“5” and the routine ends.

FIG. 24 shows the requisite/option management DB 21 and the service setup management DB 20 combined similar to FIG. 23. From FIG. 24, the service functions=“VLAN 400_1”, “VLAN 400_2, LSP 500_1, and EoMPLS 600 are constructed (results are all “OK”). It is recognized that the construction of the LSP 500_2 has failed (result is “NG”) and the provisioning status level=“4”.

Operation embodiment (4) in case provisioning failure factor becomes factor of other subsequent provisioning failures: In this embodiment (4), the wide-area VLAN service shown in FIG. 5 is defined in the same way as the embodiment (3), the provisioning is performed in order to realize the wide-area VLAN service, the provisioning of the service functions=VLAN 400_1, VLAN 400_2, and LSP 500_1, for example, succeeds, so that the provisioning of the optional “LSP 500_2” fails in the same way as the embodiment (3).

However, different from the embodiment (3), in the embodiment (4), it is analyzed that the provisioning of the subsequent service function=“EoMPLS 600” fails due to the same failure factor as that of the “LSP redundancy definition”.

The operation procedure example of the embodiment (4) will now be described. It is to be noted that since the operation procedure up to the provisioning of the requisite VLAN 400_1, VLAN 400_2, and LSP 500_1 succeeds and the provisioning of the optional “LSP 500_2” fails is the same as that of the embodiment (3), the description will be omitted. The operation after the provisioning controller 10 receives the transmission result determination of the command of the provisioning LSP 500_2 will now be described.

Steps S105-S109: In FIG. 16, since the command transmission result determination of the provisioning of the LSP 500_2 has indicated “failure”, the provisioning controller 10 converts the failure command character string 704 into the service function, and requests the analysis of whether the function ID is requisite/optional, and of the provisioning NG, thereby receiving the failure factor 714.

Step S110: The provisioning controller 10 finds that the failure factor 714, i.e. the failure factor analyzed after acquiring information by using the network status analyzer 15 and the network information acquiring portion 16 is a hardware fault of connection status of e.g. network device 200_4.

Step T401: In FIG. 14, the provisioning controller 10 develops an effect due to the hardware fault in the service function (only EoMPLS 600 in this case) for which the subsequent provisioning is performed.

Namely, since the provisioning of the LSP 500_1 required for the EoMPLS 600 has already succeeded, it is determined that there is no effect on the provisioning of the service function=“EoMPLS 600”. On the other hand, since it is found that a hardware fault is occurring in the network device 200_4 of the provisioning object for the EoMPLS function, it is analyzed that the connection between the network devices 200_4 and 200_7 is disabled.

The provisioning controller 10 deletes the other service functions which will become the provisioning failure due to the failure factor.

Steps S112-S117: In FIG. 16, when a service function remains without being deleted, the provisioning controller 10 returns to step S101 through step S111 since there is no effect of the failure factor on this service function. Then, the provisioning controller 10 performs the provisioning of subsequent service functions.

By this effect development processing, it becomes possible to perform provisioning only for the unaffected subsequent service functions.

In case of an extended VLAN service, the provisioning controller 10 determines that the service function of the EoMPLS is deleted, there is no service function to which the provisioning process is not performed, and the provisioning process is over.

1. A provisioning control apparatus which performs provisioning of network devices in order to construct a predetermined network architecture on a network composed of the network devices comprising:
a command generator generating a network setup command for making the predetermined network architecture, providing the network setup command to the network devices, and receiving a setup result from the network devices;
a network status analyzer acquiring operation status information of the network devices determined based on the setup result and outputting an analysis result of a network architecture state based on the operation status information acquired; and
a provisioning controller instructing the command generator to generate the network setup command determined based on the analysis result.

2. The provisioning control apparatus as claimed in claim 1 wherein the provisioning controller develops an effect into subsequent provisioning based on the analysis result, and determines a network setup command subsequently generated based on a result of the effect development.

3. The provisioning control apparatus as claimed in claim 1 wherein the predetermined network architecture is realized by a plurality of provisionings, a provisioning status level is associated with each provisioning, the provisioning controller updates the provisioning status level based on the setup result, and the network status analyzer determines the operation status information to be acquired based on a provisioning status level at which provisioning has failed.

4. The provisioning control apparatus as claimed in claim 3 wherein the provisioning status level is associated with a plurality of service functions composing the predetermined network architecture, a network setup command group for realizing each service function, or a network setup command.

5. The provisioning control apparatus as claimed in claim 3 wherein based on the analysis result at a time when a failure of provisioning is found, the provisioning controller switches back the provisioning.

6. The provisioning control apparatus as claimed in claim 3 wherein the provisioning controller determines whether or not provisioning of a subsequent service function is performed based on the analysis result of failed provisioning.

7. The provisioning control apparatus as claimed in claim 3, further comprising a database in which operation status information of network devices to be acquired per each provisioning is preliminarily set up, the network status analyzer determines operation status information to be acquired based on the setup result and the database.

8. The provisioning control apparatus as claimed in claim 3, further comprising a requisite/option management database indicating whether or not the provisioning is requisite, the provisioning controller aborts predetermined network architecture processing when it is determined that requisite provisioning has not been performed based on the analysis result.

9. The provisioning control apparatus as claimed in claim 8 wherein when it is determined that optional provisioning has not been set up based on the analysis result, the provisioning controller continues provisioning of a subsequent service function.
